(19) United States
(12) Patent Application Publication
(10) Pub. No.: US 2021/0199416 A1
(43) Pub. Date: Jul. 1, 2021

(54) Method of Assistance in the Maintenance of an Industrial Tool, Corresponding Tool and System and Program Implementing the Method

(71) Applicant: ETABLISSEMENTS GEORGES RENAULT, SAINT HERBLAIN (FR)

(72) Inventors: Simon Boisard, SAINT SEBASTIEN SUR LOIRE (FR); Laurent Macquet, LA CHAPELLE SUR ERDRE (FR)

(21) Appl. No.: 17/132,455

(22) Filed: Dec. 23, 2020

(30) Foreign Application Priority Data
Dec. 27, 2019 (FR) 1915676

(51) Int. Cl. G01B 7/30; G05B 23/02; G01L 5/00; G01L 3/10; G01D 5/14; G06T 7/00

(52) U.S. Cl. CPC G01B 7/30; G05B 23/0283; G05B 23/027; G06T 2207/30164; G01L 3/108; G01D 5/145; G06T 7/001; G01L 5/0061

(57) ABSTRACT

A method for assisting maintenance of an industrial tool (e.g., a screw driver or drill), implementing rotationally mobile components. The method includes: obtaining measurement data representing an angle and/or a torque during use of the tool; analyzing the measurement data to determine quality data representing possible disturbances induced for each of a set of controlled components, delivering a tool signature; storing the signature in a memory associated with the tool, and readable contactlessly at short distances; remotely reading the signature in the memory, by a terminal; identifying a component requiring action, based on the signature; obtaining, through the terminal, an intervention to be carried out, comprising 3D information on the tool; taking an image of the tool, by a camera on the terminal; displaying a representation in augmented reality, by using the image and the 3D pieces of information, identifying a defective component and/or maintenance operations to be performed.

### FIELD OF THE INVENTION

The field of the invention is that of industrial tooling and especially of tooling designed to carry out a screw driving operation or a drilling operation with one or more specified torque values.

The invention relates more specifically to the maintenance of such tools, and especially to preventive maintenance, for example to identify a defect or a state of wear and tear of the tool, and if necessary to carry out an intervention efficiently and in a simplified way.

### PRIOR ART AND ITS DRAWBACKS

In the field of industrial, motor vehicle or aircraft production for example, screwing and/or drilling tools are very widely used. These tools which can be fixed or portable (and in the latter case equipped with batteries) incorporate motors, especially electric or pneumatic motors depending on the applications envisaged. These tools are generally connected (by radio or by wired means) to a controller, or hub (which for example takes the form of a casing) making it possible especially to drive different operating cycles.

For example, in the case of a screwdriver, the screwing is enslaved and the tool carries out a measurement of torque applied to the screw by the screwdriver. This measurement is transmitted to the controller which ascertains that its value is situated within the limits stipulated by the screwing strategy. In this way, a controller can trigger the stopping of the work when the measurement of the torque attains a threshold value. The results of the screw driving operation can be recorded in quality databases for subsequent treatment and/or used by the operator to verify whether or not the tightening operation is accurate.

The controller especially ensures traceability of the operations performed by the tool, in ensuring for example the recording of the results such as the final screwing torque, the screwing speed, the final screwing angle, the date and time of operations or again the tables representing quality (good or poor depending on predetermined parameters) of the screw driving operation performed.

The measurement made by the sensor equipping the tool reflects the torque applied to the screw. This measurement is impacted by different transmission elements which add a noise to the signal measured. The screwdriver comprises at least the following elements:
a motor;
one or more epicyclic trains aimed at increasing the torque produced by the motor; and
a torque sensor.

It can also include other elements, in particular an angle transmission element or angular member.

All these elements can disturb the signal from the sensor, which then no longer perfectly reflects the torque applied to the screw. This noise can for example prompt a stoppage that does not correspond to the predefined set-point value of stoppage and therefore leads to a wrong screw driving operation even while the screwdriver sends back a positive report. In addition, the deterioration of the angle transmission elements can lead to an increase in noises on the measured signal. This increase in the noise reduces the performance of the tool (deterioration of precision) and/or of the quality of the screwing performed.

It is therefore desirable to control the precision of these screwing means and the proper state of operation of the tools, whether it is for controls and/or for the tracking of the screwing parameters for the efficient execution of these parameters,

Controls can be carried out in different ways. For example, the document FR2882287 describes a screw driving tool comprising a rotary member mounted on a body and a sensor for measuring the tightening torque. The measurement of the torque gives elements used to determine the state of wear and tear of the members. More specifically, this document teaches the processing of a spectrum of frequencies in order to extract at least one vibrational frequency associated with a rotating member, and this frequency is then compared with a reference frequency in order to determine the state of wear and tear of the rotating member considered.

This enables identification of possible defects that the screw may have but not a level of tightening precision.

There are known ways of applying preventive maintenance in which the number of uses of the tool (number of screw driving operations or accumulated time of use) is counted up and the value of this counter is compare with recommendations produced by the suppliers of tools, these recommendations resulting in a periodicity of maintenance. This method produces an empirical approach that gives a statistical estimation of the wear and tear of the tool but does not truly give its current state.

In other words, the operator, in order to carry out the maintenance of a tool, proceeds as follows:
consulting the manual and reads the instructions,
dismantling the tool,
visually inspecting the components,
identifying the defective component,
consulting the supplier to ascertain the availability of the component, place orders, etc.,
receiving and replacing the component.

This process is lengthy and therefore costly.

Besides, it can lead to unnecessary interventions (replacing a part that is not worn out) or excessively delayed action (when a worn out part is not detected).

There are also known ways of carrying out regular controls on a test bed. These controls also require a stoppage of production, the tool being shifted to the test bed, generally in a site distinct from that of the production site. This leads to a slowing down of production and/or to the use of replacement tools.

The standard ISO5393 stipulates that at least 25 test screw driving operations should be carried out to control a screw driving tool.

There is therefore, depending on the application and the tools, a need to implement an easier and more efficient technique of maintenance of a tool, especially in the detection of defective components,
a need for processing (analysis of defectiveness and action) that is speedy and done locally (and for example without the information being broadcast outside the company or the workshop),
a need for preventive detection of failure, enabling anticipation of a necessary replacement of a component,
a need to rationalize maintenance, in changing only components that are really defective,
a need for assistance in maintenance, facilitating the task of the operator entrusted with maintenance, and/or
a need for following the maintenance and the quality of the tool.

The present invention is aimed especially at providing a simple and efficient solution to this requirement.

### SUMMARY OF THE INVENTION

According to a first aspect of the invention a method is proposed for assistance in the maintenance of an industrial tool such as a screwdriver or a drill, implementing several rotationally mobile components, characterized in that it comprises the following steps:
obtaining measurement data representative of an angle and/or a torque during a use of said tool;
analyzing of said measurement data so as to determine at least one piece of quality data representative of possible disturbances induced for each of the components of a set of controlled components, delivering a signature of said tool comprising said quality data;
storing said signature in a memory associated with said tool, and readable contactlessly at short distances;
remotely reading said signature in said memory, by means of a terminal for assistance in maintenance;
identifying a component requiring action, on the basis of said signature;
obtaining, through said terminal, of information on assistance on said intervention to be carried out, comprising 3D information on said tool;
taking at least one image of said tool, by means of a camera mounted on said terminal;
displaying a representation in augmented reality on the screen of said terminal, using the image or said images, and said pieces of 3D information identifying said defective component and/or maintenance operations to be performed.

The maintenance is thus facilitated, the operator being able at any time to read the information on the state of the tool and its maintenance requirements, simply by placing his terminal, for example a smartphone, a tablet or a dedicated device, in proximity to the tool to then obtain suitable assistance information.

Thus, only the necessary maintenance actions are carried out at the most appropriate time and they are carried out easily, thanks to the information on assistance.

Depending on the implementations, the memory can be associated with a tool or a hub driving this tool. Thus, the term “associated with the tool” means especially “integrated into the tool” or “carried by the tool” (for example in the form of an optional module) or “separate but paired with the tool” for example in the hub.

As the case may be, and especially depending on the processing power available, the step of analysis can be performed by the tool and/or by the hub.

Similarly, as the case may be, the step of identifying a faulty component can be carried out by the hub which then transmits this information to the tool with the signature, the tool itself and/or the terminal.

The operator has available, directly at his terminal, a description of an operation for dismantling, identifying, assembly, etc. The 3D information on said tool, combined with the images of the tool taken by means of a camera of said terminal, provide the operator with a representation in augmented reality on the screen of said terminal, for example to identify a defective component and/or maintenance operations to be performed.

The action is thus facilitated, the operator being guided visually, directly on a view of the tool itself. The 3D information makes it possible to superimpose elements on the images guiding the operator, for example in the form of colored zones, arrows or other elements for identifying a zone, a portion or a component, a handling operation to be performed (screwing, unscrewing, positioning for insertion and/or shifting to be made, etc.), written indications, etc.

According to one particular embodiment, said step for obtaining assistance information comprises a step of connection to a remote maintenance server, containing a set of information pertaining to said tool, called a digital twin of the tool, and comprising at least one of the pieces of information belonging to the group comprising:
a 3D representation of the tool,
an exploded view of the tool,
a data sheet on the tool,
a parts list of the tool,
a report on the calibration of the tool,
a timeline of maintenance of the tool,
a theoretical signature of the tool,
an initial signature of the tool,
at least one signature preceding the tool.

The implementation of such a digital twin makes available a large quantity of data, possibly updated at each intervention, and facilitates the detection of the problems and their processing operations for each type of tool and for the tool considered especially. The invention also relates to a method of assistance in the maintenance of a tool, characterized in that said step of analysis is implemented in a hub connected to said tool, receiving said pieces of data for measuring said tool, carrying out said analysis.

This approach is useful especially when the processing capacity of the tool is not enough to carry out such an analysis, or when it is not desirable to equip the tool with such a processing capacity. In this case, the tool carries out measurements and transmits them to the hub. Should the memory be carried by the tool, a transmission from the hub to the tool and especially towards this memory is then implemented.

According to one particular embodiment, said signature comprises a plurality of frequency lines.

In this case, said step of identification can especially carry out a comparison of the amplitude of each line with a predetermined threshold value (for example, in the form of a reference signature).

As a variant or as a complement, said step of identification can also implement an analysis of the progress of the amplitude of each line between two signatures, especially the last two signatures.

According to one particular embodiment, said step of analysis takes account of an aggregation of measurement data corresponding to at least two screw driving operations. Indeed, to have reliable signature, it can be desirable to have data measured on a sufficient angular range (for example at least 720°). If a single screw driving operation does not cover such a range, it is possible to take account of several screw driving operations, preferably according to an optimized aggregation.

According to one embodiment, the invention comprises a step of guidance by said terminal, of the operator to carry out an action on a defective component.

According to one particular embodiment, the method can also include a step of prediction of wear and tear or a defect of a component, by analysis of a series of at least two signatures of said tool and/or a batch of similar tools and/or by comparison with predetermined threshold values.

The invention also relates to a tool implementing at least the steps for obtaining data on measurement and storage of a signature of the method described here above, and comprising a memory for the storage of said signature capable of exchanging said signature with a terminal via a short-distance contactless connection.

This memory is preferably readable, whether or not said tool is powered. For example, said storage memory can be an RFID memory capable of communicating according to the NFC protocol.

The invention also relates to a system of assistance in the maintenance of an industrial tool such as a screwdriver or a drill, said tool implementing several components that are rotationally mobile. Such a system comprises at least one remote maintenance server and at least one maintenance terminal capable of communicating with said tool and said server.

Said tool comprises an associated memory that is contactlessly readable at short distance, containing at least one signature comprising quality data that are representative of possible disturbances induced by each of the components of a set of controlled components, determined on the basis of an analysis of said measurement data representative of an angle and/or a torque value during the use of said tool.

Said terminal comprises means for the contactless reading of said signature and means of connection to said remote server, so as to obtain information on assistance on an action to be performed, according to an analysis of said signature.

According to one particular embodiment, said terminal comprises a camera, capable of obtaining images of said tool, and data processing means capable of presenting a representation in augmented reality of said tool on a screen, as a function of 3D data delivered by said server.

According to another particular aspect, said remote maintenance server contains a set of information elements relative to said tool, called a digital twin of the tool, and comprising at least one of the pieces of information belonging to the group comprising:
a 3D representation of the tool,
an exploded view of the tool,
a data sheet on the tool,
a parts list of the tool,
a report on the calibration of the tool,
a timeline of maintenance of the tool,
a theoretical signature of the tool,
an initial signature of the tool,
at least one preceding signature of the tool.

The invention also relates to a computer programs comprising program code instructions for implementing the control method described here above (according to any one of the embodiments mentioned here above) when it is executed on a computer and/or a microprocessor.

These programs can be implemented respectively in the tool and/or in the terminal and/or in a remote device capable of exchanging with the terminal, to carry out all or part of the steps of the control method.

### LIST OF FIGURES

Other aims, features and advantages of the invention shall appear more clearly from the following description, given by way of a simple, illustratory and non-exhaustive example with reference to the figures, of which:

FIG. 1 is a view in section of a tool integrated into a tooling set according to an exemplary embodiment of the invention;

FIG. 2 is a functional diagram of a tooling set according to an exemplary embodiment of the invention;

FIG. 3 presents, in an exemplary diagram, the variations of tightening torque as a function of the number of tightening operations performed by one and the same tool;

FIG. 4 presents a flowchart of the main steps for implementing a method for controlling a level of quality according to a first implementation;

FIG. 5a presents an example of a linear characteristic of a given stiffness, according to the first implementation;

FIG. 5b presents an example of a curve representative of the first relationship, according to the first implementation;

FIG. 5c presents an example of a curve representative of the second relationship, according to the first implementation;

FIG. 5d presents an example of a curve representative the third relationship, according to the first implementation;

FIG. 6a presents an example of a curve representative of the first table, according to a second implementation;

FIG. 6b presents an example of a curve representative of the second table, according to a second implementation;

FIG. 6c presents an example of a curve representative of an intermediate table, illustrating the fact that the tool always stops at the level of a maximum value, according to the second implementation;

FIG. 6d presents an example of a curve representative of the third table, according to the second implementation;

FIG. 7 presents a flowchart of the main steps for the implementation of the method of control of a level of quality according to a first embodiment of the invention;

FIG. 8a presents an example of two curves representative of two first tables obtained for two screwings of screws by the screwdriver of FIG. 1, according to the first embodiment;

FIG. 8b presents an example of two curves representative of two third tables corresponding to the two curves of FIG. 8a, according to the first embodiment.

FIG. 8c presents an example of curves representative of a set of intermediate aggregated tables obtained from the two curves of FIG. 8b, according to the first embodiment;

FIG. 9 presents a flowchart of the main steps for the implementing of the method of control of a level of quality according to a second embodiment;

FIG. 10a presents an example of a truncated version of a curve representative of the third table obtained for a first screwing of screws by the screwdriver of FIG. 1, according to the second embodiment;

FIG. 10b presents an example of an offset version of a curve representative of the third table obtained for a second screwing of screws by the screwdriver of FIG. 1, according to the second embodiment;

FIG. 10c presents an example of a curve representative of the third candidate aggregated table obtained by optimized concatenation of the curves of FIG. 10a and of FIG. 10b, according to the second embodiment

FIG. 11 illustrates an example of a result of analysis of measurements, for a screwdriver, enabling the definition of a signature of the tool;

FIG. 12 presents an example of implementation of the method of an exemplary embodiment of the invention;

FIG. 13 illustrates an example of a reading of a signature of a tool by an operator;

FIG. 14 illustrates an example of assistance and maintenance, using a portable terminal of an operator;

FIG. 15 is a simplified flowchart of an embodiment of the invention.

### DETAILED DESCRIPTION OF EMBODIMENTS OF THE INVENTION

The general principle of the technique described relies especially on a storage, in a memory of each tool, of a signature of this tool, containing especially data representative of the quality of the work, for example a screw driving operation, and especially the quality of each of the components of a predetermined set of components, and on the implementation of an assistance of the operator in augmented reality, to guide the operator in a maintenance action, the necessity of which is detected by analysis of the signature.

The analysis of the quality or the state of these components can especially be carried out according to the technique described in the patent document FR2882287. Other solutions are described by way of examples in the appendix, which is an integral part of the present description.

Other methods for obtaining information on the quality of work of a tool can of course be used or adapted according to the type of tool.

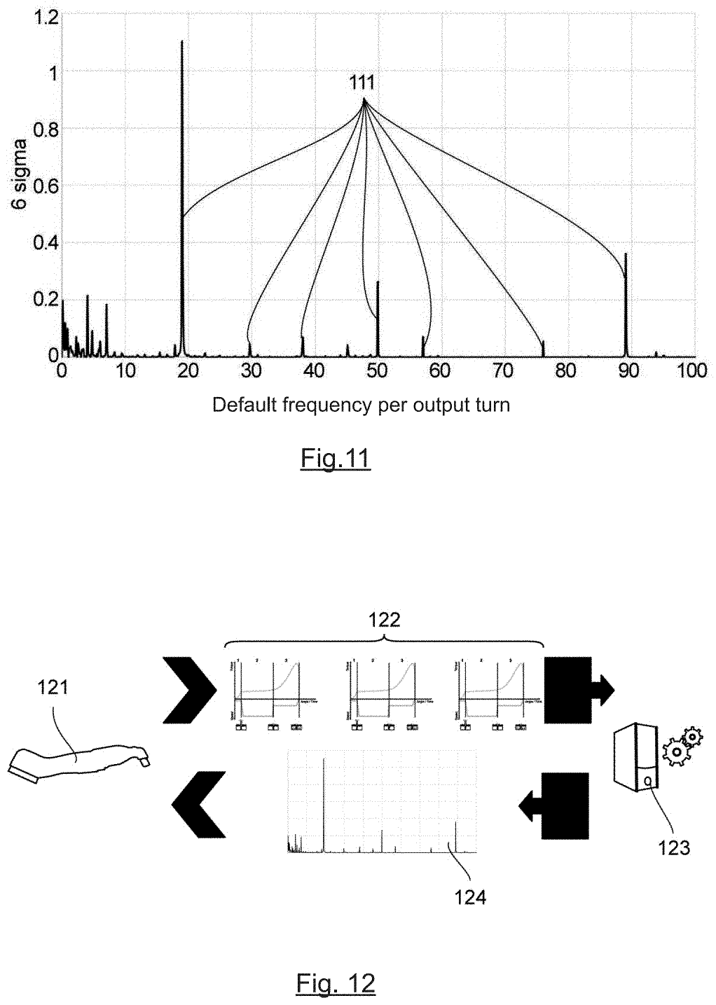

An example of results of measurements carried out on the screwing angle and the screwing torque is illustrated in FIG. 11. The histogram illustrated presents the frequency as a function of six sigma (detailed computations in the appendix). A series of peaks 111 can be seen at particular frequencies. It is known that each of these peaks corresponds to one of the components (operating frequency or harmonics) and it is therefore possible to detect a defective quality, in considering the amplitude of the peak and/or its frequency shift, relative to a reference frequency. For example, the analysis of the amplitude of the line makes it possible to determine whether the dispersion (overall or particular dispersion) is too great (for example in terms of percentage of dispersion of a line relatively to the overall dispersion).

This enables the building of a signature of the tool, for example in the form where there is associated, with each component, a value of frequency and/or in amplitude, or a simpler piece of information on quality (for example, 1 if the value or values considered are in a range considered to be acceptable and 0 if these values go beyond a predetermined threshold set by the manufacturer).

The signature can in addition contain information such as the identifier of the tool, its date of being put into service, the date of the last action, a time of use etc/

This signature is stored in a dedicated memory of the tool, for example an RFID chip which can be readable by a short-distance contactless link, for example according to the NFC standard, so that the reading is possible even when the tool is not powered.

The operator has a mobile terminal, for example a smartphone, a tablet or a dedicated terminal, capable of reading the content of the RFID chip and reading the signature of the tool.

If necessary, several signatures can be stored in the tool and for example a reference signature, corresponding to an ideal theoretical signature, an initial signature, originally during the construction of the tool and/or one or more recent signatures enabling analysis of a progress of the wear and tear of the components. As a variant, these signatures can be preserved in the operator's terminal, in the hub or in a remote server to which the terminal is connected.

As described in detail in the appendix, obtaining the signature is done by analysis of one or more series of measurements made by the tool. If this tool has a sufficient computation capacity, it can carry out the calculations itself, determine the current signature and place it in the RFID memory.

However, it is common for such tools not to have such computation capacity or power internally. In this case, the computations can be done by the hub. The tool periodically or constantly transmits to this hub the measurements made on the angle and the torque. The hub carries out the requisite processing operations, for example, according to the approaches described in the appendix, determine the signature and transmit it to the tool for storage.

This approach is schematically illustrated in FIG. 12. The tool 121 transmits to a hub 123, in this case permanently and along with the flow, the results of measurements of torque values and angle values of each screw driving operation, herein illustrated by the curves 122. The hub 123 carries out a processing of the measurement data, for example the concatenation of these data and the application of an FFT, to produce a signature illustrated by the curve 124 (corresponding to FIG. 11).

This signature is transmitted to the tool 121, which stores it in its RFID memory.

The maintenance operator can thus, at any time, read the signature of the tool whether or not it is powered, by means of a terminal, for example equipped with an NFC/RFID reader.

The operator can carry out a periodic check on all the tools for which he is responsible, simply by reading the content of the RFID memory. He can also be alerted, by an alarm.

For example, should a predetermined threshold be reached, the controller (or the tool, if necessary via the controller) can send out an alarm to report a need for maintenance on the tool or even block the tool to prevent production with the risk of sub-standard performance. These alarms can be sent out on the man-machine interface of the controller, or of the tool, but can also be sent by classic means such as Ethernet networks, field buses to shop supervision systems.

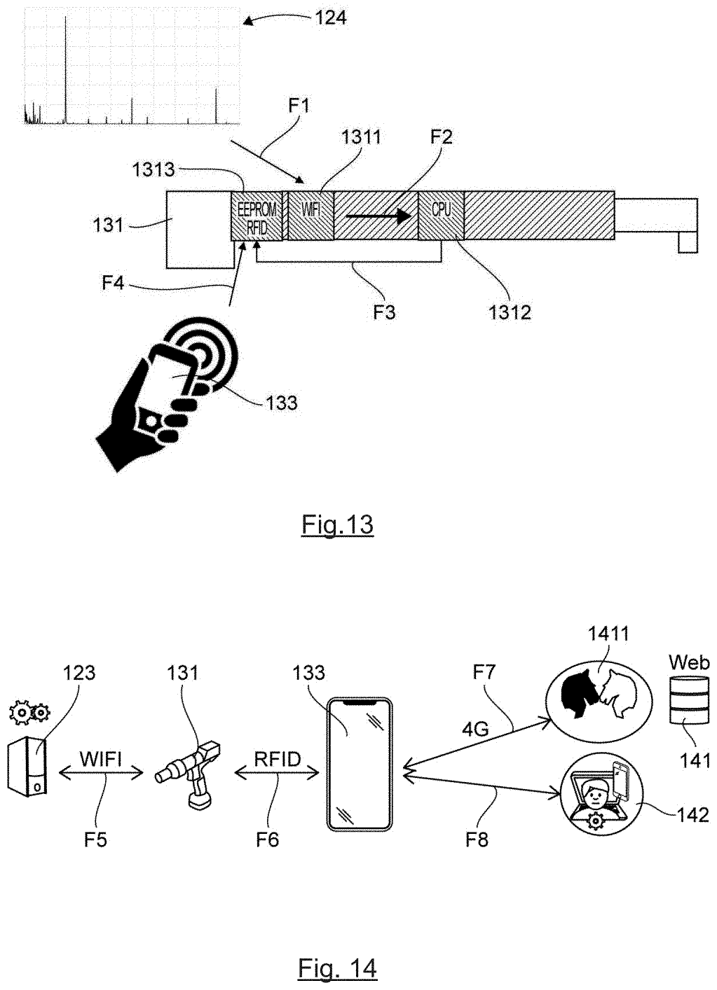

The obtaining of the signature is illustrated schematically by FIG. 13.

The tool 131 receives (F1) from the hub 123, as explained here above, the signature 124, for example via a Wi-Fi link (or any other means of communication, wire or wireless), depending on the means implemented to communicate between the hub and the tool). The means 1311 for processing the Wi-Fi signal transmit (F2) the signature to the microprocessor (CPU) 1312 of the tool, which records it (F3) in the RFID memory, for example of the EEPROM type 1313.

This operation of synchronization of the tool can be carried out at regular intervals, so that the tool keeps an up-to-date signature, representative of its current dispersion.

The terminal 133 accesses (F4) this memory 1313 to read the signature and apply a maintenance operation, if necessary, accordingly.

As a variant, the microprocessor 1312 can carry out a pre-processing of the data received from the hub. In this case, the signature comprises, as a replacement for or as a complement to the processing carried out for example according to the techniques described in the appendix, data on a component to be verified or to be replaced. This processing can also be done by anticipation by the hub. If not, this processing is done by the terminal after loading (F4) the signature and/or by a remote server to which the terminal is connected. It is indeed easy for this terminal especially if it is a telephone, to link up to a server for example via a 4G link.

This is illustrated schematically by FIG. 14. As indicated here above, the tool 131 receives (F5) its signature from the hub 123, for example by Wi-Fi. The terminal 133 reads (NFC reading of the RFID memory of the tool) (F6) this signature. It can then link up (F7) to a remote server 141, and/or contact (F8) a remote assistance server 142.

The remote server 141 can especially contain many pieces of information on the tool and its progress over time, for example in the form of a “digital twin” so as to facilitate tracking and maintenance. This digital twin can especially contain a 3D representation of the tool, its exploded diagram, and its data sheet, its parts list, its calibration report, its maintenance timeline, etc., and place these elements at the disposal of the operator on his terminal. It can also contain successive signatures transmitted by the terminal, and if necessary an analysis of these signatures, for example to identify a variation or an abnormal development. Thus, the digital twin is enriched by the current state of dispersion.

It is then possible to use the peripherals of the terminal to optimize the rendering of the information to the maintenance operator. In particular, by combining the use of the camera, of the screen, and by having available information on the tool, especially a 3D model of the tool (or more generally a piece of information to build 3D information), it is possible, using software hosted by the smartphone, to give the user a view in augmented reality of the components causing the dispersion and that potentially have to be changed, an action or a check to made, etc.

The pieces of 3D information enable the superimposition, on the images, of elements guiding the operator in augmented reality, for example in the form of colored areas, arrows or other elements for identifying a zone, a portion or a component, a handling operation or a check to be made (screwing, unscrewing, placing of an introduction and/or movements to be made), a measurement point, written information, etc.

The control and maintenance approach implemented can thus be the following:
the maintenance operator reads the RFID chip by means of his terminal to acquire the the signature of the tool;
the terminal links up to a server containing the digital twin of the tool and downloads the 3D model of the tool;
the terminal combines the information of the signature of the tool and the 3D model to highlight the components that contributes the most to the dispersion of the tool;
the maintenance operator uses the camera of the terminal to film the tool, and a processing software superimposes the downloaded 3D model on the tool and presents the defective components in augmented reality;
the operator is guided in the operation to be performed, for example dismantling, changing the part, reassembly, etc. by enhancements in the images in augmented reality, and if necessary additional information (audio, written, and other forms of information).

Once the maintenance operation has been performed, it is recorded in the digital twin, with the serial numbers of new components that may have been mounted in the tool. These pieces of information, stored in a server, can also enable a statistical analysis of several maintenance operations performed, to detect fragile or brittle components, identify causes of defective quality, adapt the instructions, send out preventive maintenance recommendations, etc.

This can also facilitate management of stocks, anticipate orders for components, bring about product development, etc.

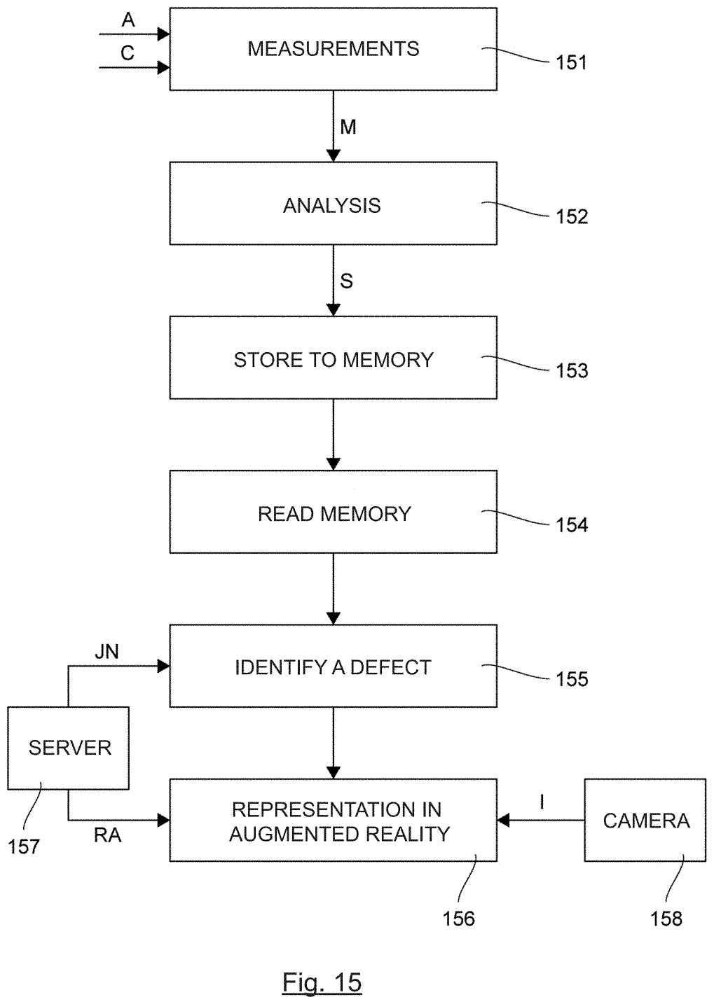

The method of the invention according to one embodiment is summarized in FIG. 15.

The tool periodically or permanently carries out (151) measurements M of the torque C and/or the angle A, which are then analyzed (152) to determine a signature S. If the tool has sufficient processing capacity, this analysis is performed internally. If not, the measurement data M are transmitted to an external device, for example a hub 123, which determines this signature S and returns it to the tool, which stores it (153) in its internal memory. It is of course also possible to distribute the analysis processing between the tool and the hub.

Thus, the tool permanently has information in its memory that can be read remotely, for example by RFID. The maintenance operator can at any time, without interrupting the use of the tool or being required to move it to a maintenance space, read (154) the content of the memory and obtain the information needed for maintenance, and especially the signature S.

The remote server 157 contains reference information, for example a digital twin JN of the tool and/or a reference signature, which enable identification (155) of a possible defect D (faulty component, need for adjustments or action, etc.) by comparison with the signature S. Depending on the processing capacity available, this identification of defects can be carried out by the terminal and/or the server.

To assist in the operator in resolving this defect D, a representation in augmented reality is provided (156) on the screen of the terminal, combining images I of the tool obtained by means of a camera 157 carried by the terminal and complementary information RA provided by the server 158, especially in 3D information as well as, if necessary, instructions, animations, illustrations, etc. guiding the operator in his maintenance operations. If necessary, information can also be projected directly on the tool, from the terminal if it has a means of projection.

### Appendix

### 1. Example of a Tool Implementing the Technique of the Invention

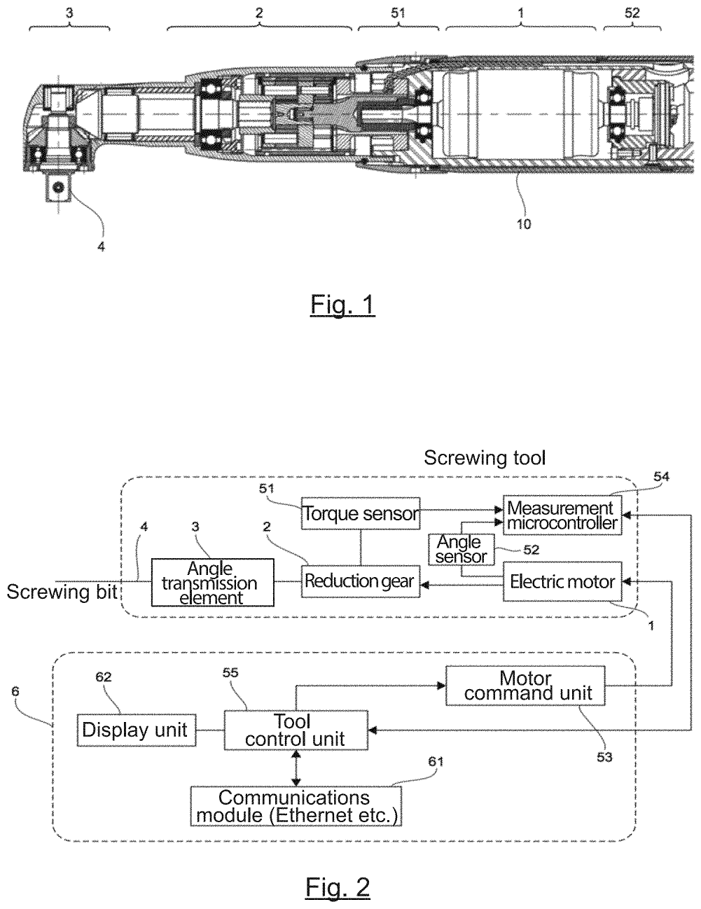

Referring to FIG. 1, a screw driving tool according to the present embodiment comprises a motor 1 mounted in the body 10 of the tool, the motor output being coupled to a gearing or reduction gear 2 formed by epicyclic gear trains, itself coupled to an angle transmission gearing 3 (the screwing axis is herein perpendicular to the drive axis; the angle transmission gearing 3 can be absent in the event of another embodiment that can be envisaged, according to which the screwing axis and the motor axis are coaxial) intended to rotationally drive a screw head having a bit 4 designed to receive a screw bush.

In a manner known per se, a torque sensor 51 (for example a bridge of strain gauges) delivers information on the tightening torque exerted by the tool. An angle sensor 52 is also provided in the rear of the motor. It can for example comprise a magnet rotating before a Hall-effect sensor carried by an electronic board.

In the functional diagram of FIG. 2, the mechanical elements are this time represented in schematically so as to show the motor 1, the reduction gear 2 and the angle transmission element 3. As illustrated, the torque sensor 51 is connected to a measurement microcontroller 54 which transmits the data to a control unit 55 of the tool.

Depending on the data given by the torque sensor 51, a control unit 55 drives the operation of the motor 1 by means of a command unit 53.

The control unit 55 furthermore incorporates means for processing the signal given by the torque sensor 51 to deliver at least one piece of information representative of a dispersion and/or of a deviation relative to said screwing objective, resulting from disturbances generated by the screwdriver.

According to the present embodiment, the control unit 55 and the command unit 53 are integrated into a unit 6, designated by the term “screw driving controller” in FIG. 2.

The screw driving controller 6 comprises or may be formed by a microprocessor or microcontroller, implementing a program, stored in an internal or external memory, allowing in particular to execute the steps of the process of an exemplary embodiment of the invention, for example according to the modes of realization described hereafter. It can also integrate or control:
a communications module 61 enabling the connection of the controller 6 to an information exchange network, for example of the Ethernet type;
a display unit 62.

Thus, when the controller 6 detects that the value of dispersion or deviation relative to the set-point value no longer meet production requirements, a warning signal and/or message is displayed on the display unit 62, and, if necessary, sent to a remote station by means of the communications module.

In the case of a battery-operated tool, the control functions of the tool 55 and the command functions of the motor 53 can be integrated into the tool.

According to one embodiment, such a message can indicate the defective element concerned, for example by comparison of the individual dispersion with threshold values or a percentage of the dispersion, and can also specify the type of maintenance and/or servicing work to be performed.

It may be recalled that the screwing torque is determined on the basis of a voltage transmitted by the torque sensor 5.

### 2. Control of a Level of Quality of the Screw Driving Operation

After having given details by examples of the main devices for the implementing of one or more embodiments of the invention, we shall now explain how these devices cooperate in the context of a method of control of a level of quality of screw driving by a tool.

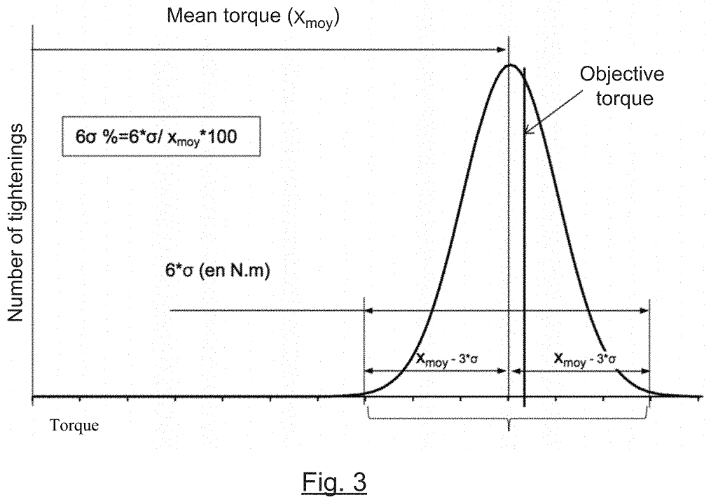

The curve of FIG. 3 illustrates the variations of tightening torque as a function of the number of tightening operations measured. This curve is prepared on the basis of several measurements (for example 25 to 100) enabling the performance of statistical studies on the behavior of a tool. The exploitation of the results especially gives the following two pieces of data:
the dispersion of the tightenings of the tool, characterized by a mean standard deviation (σ), providing information on the capacity of the tool to reproduce a torque value with precision. The dispersion is generally expressed as six times the mean standard deviation divided by the mean in percentage;
the deviation relative to the objective, evaluated by computing the difference between the mean and the objective, divided by the objective. The preliminary calibration of the screwdriver relative to the objective is aimed at having the smallest possible deviation.

The measurement curve typically has the shape of a Gaussian curve, the quasi-totality of the tightening operations (99.73%) in the test performed being situated in the 6σ zone.

To accurately estimate the precision of the tool during a single screw driving operation (or on a borderline number of tightening operations) it is necessary that all the defects should be present on the torque curve. Now a defect that occurs once per turn of an output shaft of the screwdriver will not necessarily appear if the screwdriver needs a 30° rotation in order to be tightened. A minimum angle of rotation by 720° (at least two turns to analyze the low frequencies) of the output shaft is desirable (obtained on one screw driving operation or, according to an exemplary embodiment of the present invention, several screw driving operations).

The disturbances prompting variations of torque from one screw driving operation to another have various origins such as the meshing or engagement of the gear teeth or again electrical disturbances of the signals by the magnetic field of the motor which generate deviations between the measurement of the torque and the torque actually applied to the screw.

These disturbances are characterized by an oscillation of the measurement of the torque of the tool about what would be the value really applied to the screw if it were to be measured in real time by a sensor placed between the screw and the screwdriver.

This oscillation occurs at variable frequencies and amplitudes depending on the origin of the disturbances.

In the context of the present description, it is assumed that the amplitude of the disturbances is proportional to the instantaneous torque provided by the screwdriver. This has the consequence wherein the dispersions and deviations are of the same level whatever the tightening torque.

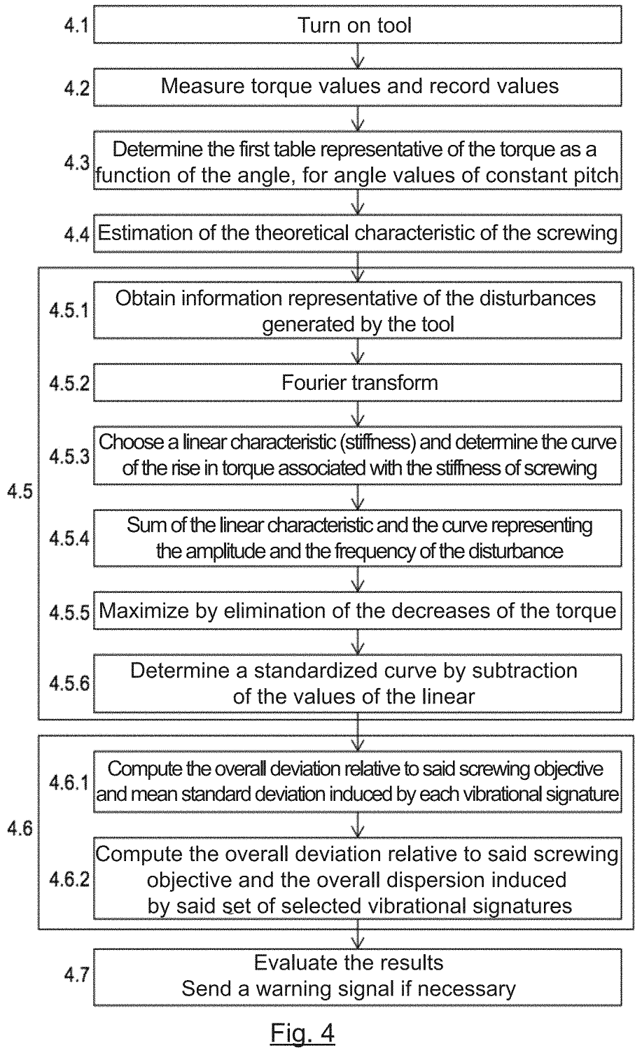

According to the estimation results, the method that is the object of an exemplary embodiment of the invention comprises a step for sending a warning signal when the controller 6 detects that the dispersion or deviation relative to this set-point value of the tightenings no longer meets production requirements. This alert responds to quality constraints but also security constraints. An alert can also be generated during the detection of an abnormal amplitude of disturbance of a component, with a view for example to carrying out a diagnostic. This can especially be rendered in the form of a table presenting the dispersions and the deviations for each disturbance, as explained in greater detail here below, with reference to the step 4.7 of the method of FIG. 4.

It is also possible, during a maintenance test, to estimate the dispersion and deviation of the set-point value of the tightenings of the screwdriver for usual test stiffness values, thus enabling a rapid control of the tool.

It can be noted that this estimation does not take account of certain effects of the screwdriver such as insufficient braking of the motor when the tightening objective is attained. It is in fact not easy and hardly necessary to determine what happens after the motor stops.

One of the aspects of the invention consists in computing what would be the dispersion of a screwdriver tool and its mean deviation relative to the tightening objective from the disturbances detected on the signal produced by its torque sensor 51. This evaluation can be carried out during a single tightening operation performed on a production line for example. This evaluation is therefore far more rapid than the one consisting in carrying out a diagnostic generally requiring several tens of tightening operations on a test bed.

Examples of processes of the invention, which can be implemented on a microprocessor and/or in a computer, are described below.

### 3. Examples of the Method for Controlling Screw Driving Operations

### 3.0 Glossary

In the context of the present description and of the claims:
“first table” is a table of doublets each comprising an angle value and a torque value. Such a first table is representative of the rise in torque of the screwing of a screw;
“second table” is a table containing a series of values representative of the true characteristic of the screw as a function of the angular pitch;
“third table” is a table of values presenting the torque as a function of the angle. Such a third table is representative of the disturbances induced by the screwdriver during the rise in tightening torque;
“third unit screwing table” is a third table obtained from a given screw driving operation. At least two third unit screwing tables are taken into account: these are called a third table of a first screw driving operation and a third table of a second screw driving operation, according to the method according to an exemplary embodiment of the invention;
“third truncated screwing table” is a third unit screwing table from which data relative to one or more measurements are eliminated;
“third intermediate table” is a third table containing data coming from at least 2 third unit screwing tables and/or third truncated screwing tables;
“third aggregated table” is a third table containing data coming from at least 2 third unit screwing tables and/or third truncated screwing tables comprising a number of values considered to be sufficient to carry out an analysis of the disturbances induced by the screwdriver;
“third candidate aggregated table” or “third selected aggregated table” is a third table selected from among at least two “third aggregated tables” according to a criterion of optimization.

### 3.1 First Implementation of a Screw Driving Control Method

Referring to FIG. 4, a first implementation shall now be described. FIG. 4 presents a flowchart of the main steps for the implementing of a method of control of a level of quality of screwing of a screwdriver, relative to a predetermined screwing objective, according to a first example of an embodiment.

At the step 4.1, the tool, a screwdriver for example, is put into operation and carries out a job according to a screwing strategy for example. During the task, the sensors measure the value of the torque (sensor 51) and the angle (sensor 52) in referencing these measurements in relation to time. The measurements are taken every millisecond for example (step 4.2). The values from the sensors 51 and 52 are transmitted to the controller 6.

The controller 6 memorizes the values of the measurements and processes them in order to produce a table of doublets of torque values and angle values as a function of time, for example at predetermined time intervals. This table is called a “rough table”. At the step 4.3, the controller determines a table representative of the torque as a function of the screwing angle, for angle values of constant pitch, to prepare a first table of doublets representative of the rise in torque of the screwing of at least one screw, each doublet comprising an angle value and a torque value. The step consists in:
determining (I) an angular pitch, which can be chosen arbitrarily and can, for example, correspond to a mean pitch situated between two values. It corresponds in the latter case to the deviation between the final angle and the initial angle divided by the number of points between the two:

$$Δθ = \frac{{θ}_{n} - {θ}_{0}}{n}$$

Thus, each new angle is computed as follows:

θ′ᵢ=i×Δθ;
Compute (II) the torque samples for each new defined angle. To carry out this second computation (II), according to a first approach, this computation can implement a linear interpolation between two torque values of the first series:

$${C}_{l}^{′} = {C}_{i} + \frac{( {C}_{i + 1} - {C}_{i} ) \times ( {θ}_{i}^{′} - {θ}_{i} )}{{θ}_{i + 1} - {θ}_{i}}$$

Other approaches, especially by polynomial interpolation of the first series of measurements, can also be used.

At the end of the step 4.3, the controller 6 sets up a series of values 51 which represents the value of the torque as a function of the angular pitch (each torque value being computed for constant angular pitch values).

We thus obtain the first table, representative of the relationship:

C_{capteur}=f(α)

obtained from doublets representative of the rise in torque value of the screwing of at least one screw, recorded in the first table (“capteur” means “sensor”). This first table makes it possible to remove any dependence on the speed of rotation of the tool which can vary during the screw driving operation.

At the step 4.4, the theoretical characteristic of the assembly is estimated. This step determines an image of the true characteristic of the screw in computing a theoretical characteristic.

Several methods of digital processing (filtering) are possible such as:
linear regression applied to the table of torque values as a function of the angle.
polynomial regression applied to the table of torque values as a function of the angle.
low-pass filter having as its cut-off frequency the default value having the lowest frequency. This method enables the payload part of the disturbances to be preserved in eliminating especially possible defects of the screw, which may be not linear. At the end of this step, the controller 6 updates a second table containing a series of values S2 representative of the true characteristic of the screw as a function of the angular pitch (at constant angle pitch). This series of values can be expressed by the formula:

C_{caractéristique vraie}=g(α)
(“caractéristique vraie” means “true characteristic”)

At the step 4.5, the part of the signal resulting from the disturbances generated by the tool can be at this instant isolated and quantified. According to one implementation, this step can be broken down into several sub-steps:

1°] The step 4.5.1 consists in choosing from the first table only the pieces of information representative of the disturbances generated by the tool.

For the same angle, the torque values of said second table are subtracted from the corresponding torque values of the first table. The result of these subtractions is divided by the corresponding torque values of the second table, this value being expressed in percent.

ΔC%=(f(α)−g(α))/g(α)

We thus determine the values of the third table.

In a second stage, at the step 4.5.2, the discrete Fourier transform is computed on this table in order to carry out a frequency analysis of the signal and reveal the different disturbances which appear in the form of a line characterized by a certain frequency. The table below presents an example of the values representative of the frequency and amplitude of each disturbance detected.

| Disturbance | Frequency | Amplitude |
|---|---|---|
| 1 | f1 | A1 |
| 2 | f2 | A2 |
| — | — | — |
| N | fn | An |

n varies for example from 1 to 1000.

It can be noted that, according to this mode of computation, the errors are considered to be independent of the torque or have little influence on its value.

2°] At the sub-step 4.5.3, a linear characteristic having a determined stiffness is chosen. This stiffness is an input parameter defined normatively, for example: sharp angle (30°)-elastic angle (360°), or between the two (in particular, this characteristic can be the true characteristic of the real assembly, defined by the second table). The tightening angle to be simulated αᵥᵢₛ (“vis” means “screw”) is selected.

The dispersion is evaluated for each frequency fi present in the above table. The table for the rise in torque as a function of the angle associated with this stiffness is expressed as follows:

$${T}_{R} ( α ) = \frac{α}{{α}_{vis}} \cdot {C}_{consigne}$$

where:
T_{R} is the torque of the linear characteristic,
αᵥᵢₛ is the total angle of the screw driving operation (from 0% to 100% of the torque in degrees),
C_{consigne} is the setpoint value torque (in Nm) (“consigne” means “set-point value”).

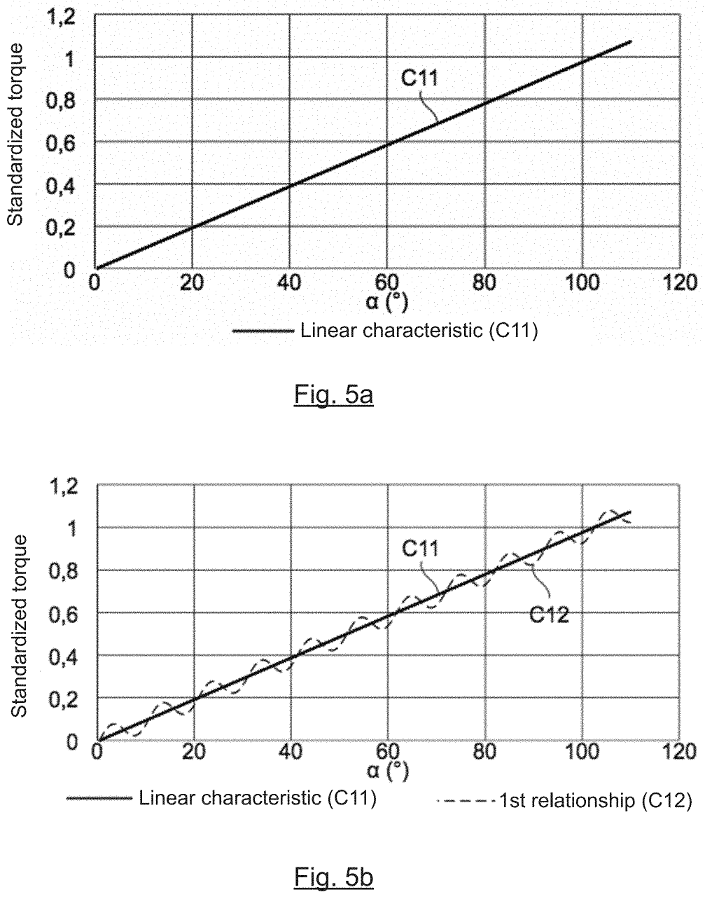

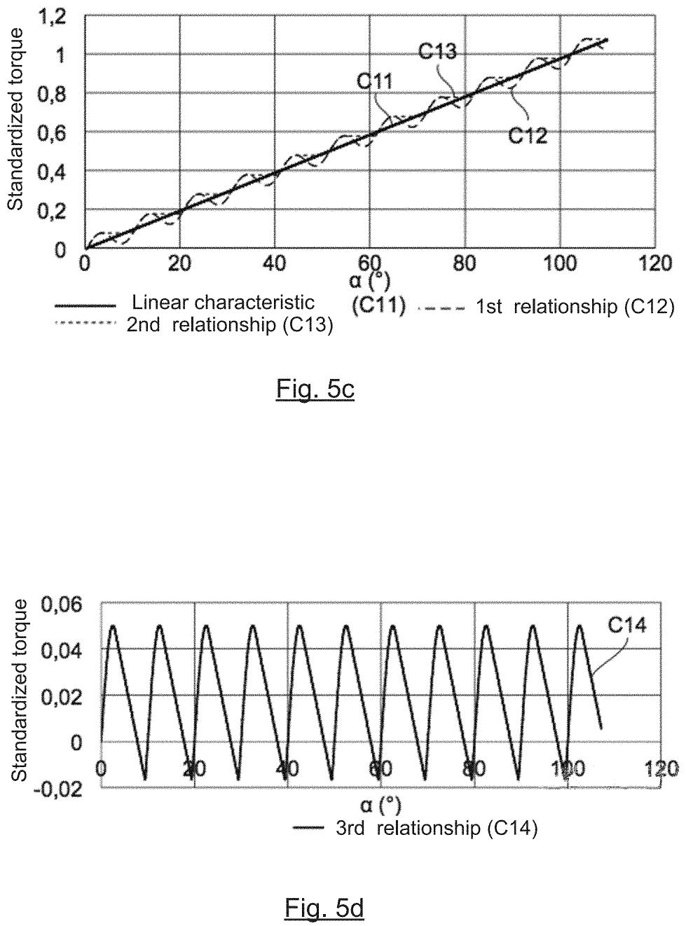

In this implementation, the real torque is considered to be perfect, i.e. the torque increases proportionally with the angle (FIG. 5a). The curve C11 illustrating this linear characteristic is a straight-line segment, the slope of which is a function of the tightening angle.

3°] At the sub-step 4.5.4, the controller 6 determines a first mathematical relationship T_{c} obtained by the sum of the curve C11 (the linear characteristic) and the sine curve, of which the amplitude and the frequency are those of the disturbance considered. The computation of this relationship of addition of the sine curve is implemented for each disturbance.

This expresses a first relationship:

T_{c}(α)=T_{R}(α)+C_{consigne}.A .sin(2.π.f.α)

where:
T_{c} is the torque measured by the sensor 5 (in Nm),
A is the relative amplitude of the defect in relation to the setpoint value torque C_{consigne} derived from the FFT (%),
f is the frequency of the disturbance (deg-1).

An example of a curve C12 produced by this first mathematical relationship is presented at FIG. 5b.

4°] At the sub-step 4.5.5, the controller 6 determines a second mathematical relationship, which expresses the fact that the stoppage of the tool does not take account of the decreases in torque. This second relationship Tₛ flows from the first relationship and is expressed as follows:

$${T}_{S} ( α ) = {max}_{0 \leq X \leq α} {T}_{c} ( x )$$

The torque values are maximized so as to eliminate the decreases, thus producing a second relationship expressing a torque as a function of an angle. In other words, Tₛ is a fictitious representation of a torque value that increases constantly, i.e. for which the stoppage of the tool cannot be activated on a torque value below a value previously attained during the job. According to this fictitious representation, the stopping of the tool does not take place during a reduction of the torque but during the attaining of a “maximum” value.

An example of a curve C13 illustrating this second mathematical relationship is presented in FIG. 5c.

5°] During the sub-step 4.5.6, the controller 6 deduces, from this second relationship, a third relationship which corresponds to a subtraction, from the values obtained by means of the second relationship, of the corresponding values of the linear characteristic. This third relationship is expressed mathematically as follows:

T_{S}(α)−T_{R}(α)

The table thus obtained is illustrated by the curve C14 of FIG. 5d.

Thus, at the end of the five steps 4.5.1 to 4.5.6, which are described here below according to one exemplary embodiment, the controller 6 can determine the dispersion and/or the deviation relative to the objective resulting from each disturbance generated by the tool (step 4.6).

In a first stage, at the step 4.6.1, the controller 6 evaluates the individual influence of the disturbances on the dispersion and/or the deviation of screwing relative to the objective.

According to one particular case, when the linear characteristic is selected at the step 4.5.3, the computation of the dispersion and of the deviation relative to the objective is done in considering an assembly stiffness that can be chosen independently of the stiffness of the assembly on which the values of the first series were collected. According to one alternative embodiment, several computations of dispersion and deviations are performed using several stiffness values, for example the standardized stiffness values used to define a sharp assembly and an elastic assembly and a stiffness proper to the application.

During the computation of the dispersion and deviation relative to the objective, the disturbances caused by the tool are considered one by one so as to evaluate, for each disturbance, its contribution to the overall disturbance.

According to one implementation, the evaluation of the individual influence of the disturbances on the dispersion and the deviation of screwing relative to the objective is done at the end of the following steps:
computing the mean of this difference over a period. This mean is representative of the divergence between the torque generated by the tool and the tightening torque objective. It is expressed as follows:

$$\overline{x} = {C}_{consigne} - f {\int }_{0}^{\frac{1}{f}} ( {T}_{S} ( α ) - {T}_{R} ( α ) ) d α$$

computation of the mean standard deviation of this third relationship. This standard deviation represents the dispersion introduced by the line on the torque generated by the tool. It is expressed as follows:

$$σ = \frac{1}{\overline{x}} \times \sqrt{{\int }_{0}^{\frac{1}{f}} {( {T}_{S} ( α ) - ( {T}_{R} ( α ) - {C}_{consigne} + \overline{x} ) )}^{2} d α }$$

These computations are repeated for each value of n (most of the values are close to 0, and not significant). The highest values correspond to possible defects. With the characteristic frequencies of each element of the tool being known, it is possible to determine the defective element or elements).

In a second stage, at the step 4.6.2, the controller 6 evaluates the influence of the set of disturbances on the dispersion and the deviation of screwing relative to the objective, in doing so for the stiffnesses or stiffness values of assembly chosen here above.

According to one exemplary embodiment, the computation is done in carrying out the following computations:
the averages are added up, and the value thus computed represents the deviation between the torque generated by the tool and the tightening torque objective for all the lines and therefore the disturbances induced by the tool. It is expressed as follows:

$${x}_{moy} \geq {C}_{consigne} - {\sum }_{i = 1}^{n} ( {\overline{x}}_{i} - {C}_{consigne} )$$

With i varying from 1 to n, i representing each of the disturbances.
the mean standard deviations are aggregated to give a value representative of the dispersion induced by the set of lines. It is expressed as follows (formula 1):

$$6 σ \leq \sqrt{{\sum }_{i = 1}^{n} {( 6 {α}_{i} )}^{2}}$$

$$Indeed \text{:} {σ}_{X + Y} = \sqrt{{{σ}_{X}}^{2} + {{σ}_{Y}}^{2} + 2 {σ}_{X} {σ}_{Y} ρ ( X , Y )}$$

$$Now \text{:} - 1 \leq ρ ( X , Y ) \leq 1$$

$$Therefore \text{:} {{σ}_{X}}^{2} + {{σ}_{Y}}^{2} + 2 {σ}_{X} {σ}_{Y} ρ ( X , Y ) \leq {{σ}_{X}}^{2} + {{σ}_{Y}}^{2} + 2 {σ}_{X} {σ}_{Y}$$

$$Knowing that \text{:} {{σ}_{X}}^{2} + {{σ}_{Y}}^{2} + 2 {σ}_{X} {σ}_{Y} + {( {σ}_{X} + {σ}_{Y} )}^{2}$$

$$We obtain \text{:} {σ}_{X} {σ}_{Y} \leq \sqrt{{{σ}_{X}}^{2} + {{σ}_{Y}}^{2}}$$

This computation (formula 1) therefore makes it possible to verify the presence of an increase of the dispersion by the sum of the square of the dispersions computed for each defect.

According to one particular implementation and by security, the value obtained is increased relative to the real value.

At the step 4.7, tests are performed in order to determine whether the dispersion and the deviation are situated in the acceptable range and, if not, an alert is sent out. The results can be delivered in a table of the following type:

| | Dispersion | | Deviation | |
|---|---|---|---|---|
| Angle | Evaluation | Threshold | Evaluation | Threshold |
| 30° | σ₃₀ | | x̅₃₀ | |
| 360° | σ₃₆₀ | | x̅₃₆₀ | |
| Special angle | σ_{special} | | x̅_{special} | |

Using such a table, it is possible to extract the dispersion and deviation for a given angle (case of a diagnostic, for a desired application of the client, an analysis is made for a given angle. This makes it possible to identify a defective component if any).

The following table presents the values of dispersion and deviation for each disturbance:

| | Dispersion | | Deviation | |
|---|---|---|---|---|
| Disturbation | Evaluation | Threshold | Evaluation | Threshold |
| 1 | σ₃₀ | | x̅₁ | |
| 2 | σ₃₆₀ | | x̅₂ | |
| — | — | | — | |
| n | σ_{special} | | x̅ₙ | |

This table can be used to identify components generating abnormal imprecision, each of the disturbances 1 to n being associated with one of these components.

The exemplary embodiment of the method for controlling a level of quality of the work of a tool that has just been described in the above pages is considered to be the most precise.

Another implementation shall now be described in the form of another example. This implementation describes a method that is simpler but appreciably less precise.

### 3.2 Second Implementation of a Method for Controlling a Screw Driving Operation

This other implementation does not integrate any FFT computation and therefore does not lay down particular conditions on the recording of the torque table.

In a first stage and in a manner identical to the first implementation, the torque table expressed as a function of the angle is computed and recorded. The result of this step is a series of values forming the first table, and expressing:

C_{capteur}=f(α)

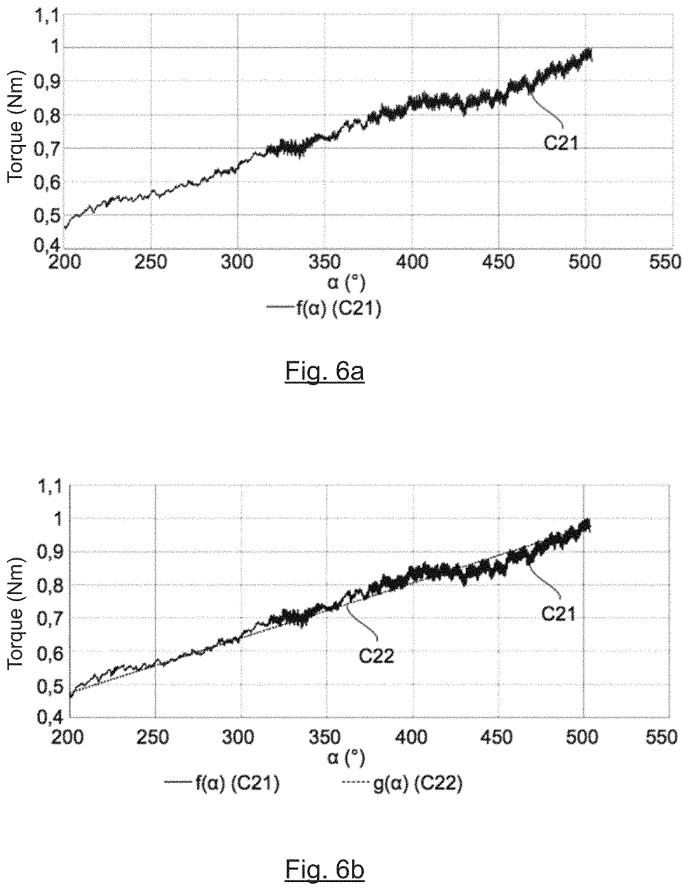

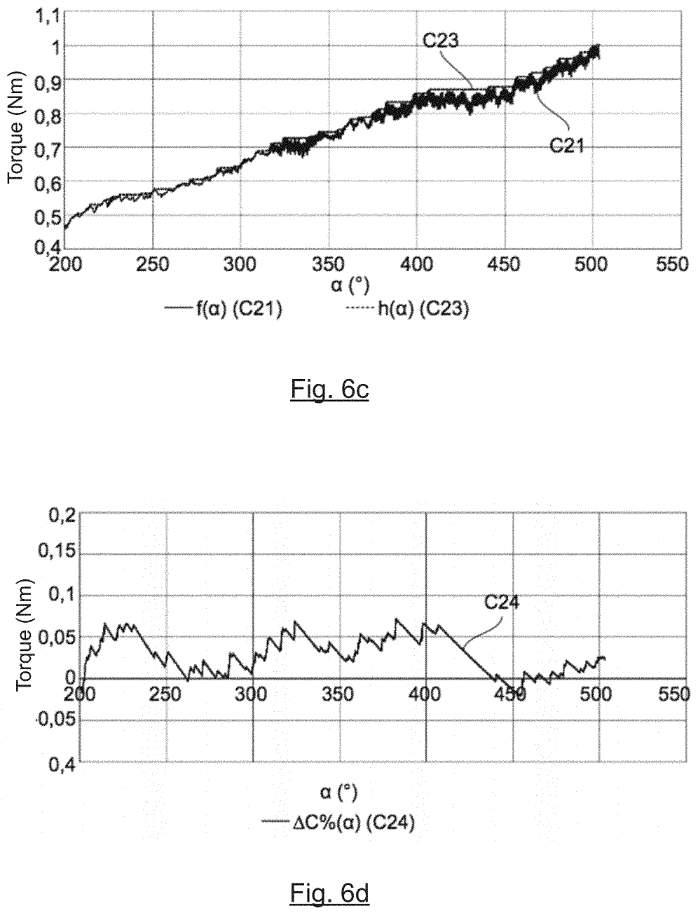

FIG. 6.1 illustrates an example of a curve C21 representing this first table.

At a second stage and identical to the first implementation, the controller 6 determines the theoretical characteristic of the screw, which is an image of the true characteristic. The result from this step is a series of values forming the second table, and expressing:

C_{caractéristique vraie}=g(α)

FIG. 6.2 illustrates an example of a curve C22 representing this second table, superimposed on the curve C21.

At a third stage and in a manner different from the first implementation, the controller 6 isolates the portion of the signal resulting from the disturbances generated by the tool. This third stage is sub-divided into several steps:

I] determining, from the torque table transmitted by the tool as a function of the angle, of a first relationship expressing the fact that the stoppage of the tool does not take account of the decreases in torque. The table thus determined is expressed as follows:

$$h ( α ) = {max}_{0 \leq x \leq α} f ( x )$$

With h(α) being the torque (Nm) computed by the controller 6 which expresses the fact that a stoppage of the tool cannot be activated on a torque value below a value previously attained during the tightening. As in the case of the previous method, the tool always stops at the level of a maximum.

FIG. 6.3 illustrates an example of a curve C23 representing this table, superimposed on the curve C21.

II] determining a second relationship which expresses the differences between the first relationship and the theoretical characteristic. In other words, this second relationship gives, as a function of the angle, the difference between the torque table computed at the previous step and the theoretical characteristic of the screw (second table, S2). This results in a series of values expressing:

ΔC=h(α)−g(α)

III] determining a third relationship obtained by standardizing the second relationship relative to the theoretical characteristic; this step consisting in taking the ratio between the difference and theoretical characteristic of the screw. This results in a series of values constituting the third table and expressing:

ΔC%(α)=(h(α)−g(α))/g(α)

FIG. 6d illustrates an example of a curve C24 representing this third table.

In a fourth stage, the dispersion and the deviation relative to the objective resulting from said part of the signal which itself results from the disturbances generated by the tool are computed. This step enables the computation of the dispersion and deviation relative to the tightening objective that are induced by all the disturbances.

The mean of this difference on the totality of the signal is first of all computed. This mean is representative of the deviation between the torque generated by the tool and the tightening torque objective. It can be expressed by the following equation:

$$\overline{x} = {C}_{consigne} - \frac{1}{n} {\sum }_{y = 1}^{n} Δ C \% ( y )$$

The mean standard deviation of this third relationship is then computed. This standard deviation is representative of the dispersion introduced by the torque measured by the tool. It can be expressed by the following equation:

$$σ = \frac{1}{\overline{x}} \times \sqrt{\frac{1}{n} {\sum }_{y = 1}^{n} {( Δ C \% ( y ) - {C}_{consigne} + \overline{x} )}^{2}}$$

where n here represents all the points of the measurement during the work of the tool.

Unlike the first implementation in which only one period is taken into account because they are all considered to be identical, the second implementation takes account of each oscillation. This second method has the advantage of considering disparities, if any, between the oscillations.

In a fifth stage, and similarly to the first implementation, the results of evaluation and an alert if necessary is/are sent out.

This second implementation is however appreciably less precise because it does not enable results to be obtained for each disturbance frequency, and therefore does not enable each component to be tested individually.

An exemplary embodiment of the present invention thus makes it possible especially to determine whether or not a tool is capable of carrying out the work asked of it, in real time and on the assembly line. An exemplary embodiment of the invention can also be used to make a visual determination of the results of the measurement, whether or not the work, a screw driving operation for example, has been properly done. Since the values characterize the disturbances detected and computed during a job with the part produced, it is possible to carry out a posteriori quality control of the parts produced and thus raise questions about the quality of certain parts if it turns out that the amplitude of the disturbances has been too great.

The method of an exemplary embodiment of the invention makes it possible especially to provide, according to needs and applications, at least one of the following elements:
a warning as to whether the dispersion or the deviation with respect to the setpoint value of tightening operations no longer meets production requirements, this being the case possibly when the screwdriver is being used in production (quality/security aspect);
an estimation of the dispersion and a deviation relative to the setpoint value of the tightening operations by the screwdriver for the usual test stiffness values, this being the case possibly during a maintenance test (fast controls aspect);
the detection of an abnormal amplitude of disturbance of a component and the generation of a warning (diagnostic aspect).

An exemplary embodiment of the invention thus makes it possible, in particular:
to warn the user in real time about the incapacity of a screwdriver to accurately perform the work, for example during the use of the tool on an assembly line;
to speedily provide, in real time, an estimation of the dispersion and the deviation relative to the tightening objective;
to generate a warning if a component of the screwdriver gets abnormally deteriorated, especially to enable the tool assembler or the maintenance technician to identify the defective component or components.

Although the invention has been described through a certain number of detailed embodiments, the proposed method and the corresponding devices comprise different variants, modifications and improvements that shall be obvious to those skilled in the art, it being understood that these different variants, modifications and improvements are part of the scope of the invention, as defined by the following claims. In addition, different aspects and characteristics described here above can be implemented together, or separately, or else substituted for one another, and the set of the different combinations and sub-combinations of the aspects and characteristics form part of the scope of the invention. In addition, it can happen that certain devices described here above do not incorporate the totality of the modules and functions planned for the implementations described.

### 4 Embodiments of the Method of the Invention

As indicated here above, a minimum angle of rotation of 720° (at least two turns to analyze the low frequencies) of the output shaft is generally desirable. When a single screw driving operation does not cover this minimum angular range, it is therefore desirable to take account of the measurement readings taken from two or more screw driving operations.

The data obtained from these different screw driving operations must then be combined, or concatenated, to implement the technique described here above and especially to build the tables described here above. This concatenation however cannot be implemented without preliminary processing, the technique described here above taking account of the periodicity of the signal represented by the measurements and processing operations.

Thus, an exemplary embodiment of the invention proposes a method for controlling a level of quality of screwing by a screwdriver relative to a predetermined screw driving objective taking account of a series of data that are representative of the rise in torque of at least two screw driving operations at a predetermined angular frequency. It comprises the following steps:
obtaining a sub-series of data for each of said screw driving operations, corresponding to a sub-series of measurements;
optimized aggregation of said sub-series to form said series of data, comprising a step of elimination of data corresponding to a determined number of measurements according to a criterion of optimization of periodicity; and
analysis of said series of data, delivering said at least one piece of information representative of a dispersion and/or a deviation relative to said screw driving objective, resulting from the disturbances induced by said screwdriver.

In other words, the concatenation, or aggregation, of data coming from two (or more) sub-series of measurements does not preserve all the available data, although the primary objective is to have a sufficient angular range available. On the contrary, certain pieces of data are eliminated, so that the signal resulting from the processing of the data preserved has characteristics of periodicity that are efficacious for determining the information on dispersion and/or deviation.

The purpose of this elimination, in substance, is to provide a final signal that is as periodic as possible or, in other words, it is that the link between the two signal portions, corresponding to two screw driving operations taken into account, should be as linear as possible (i.e. that the slopes of the two signal portions, at the level of their junction, should be as close as possible to each other so that this junction is as “smooth” as possible, without introducing any sudden transition that would disturb the analysis).

Two embodiments are described here below.

### 4.1 First Embodiment of the Invention

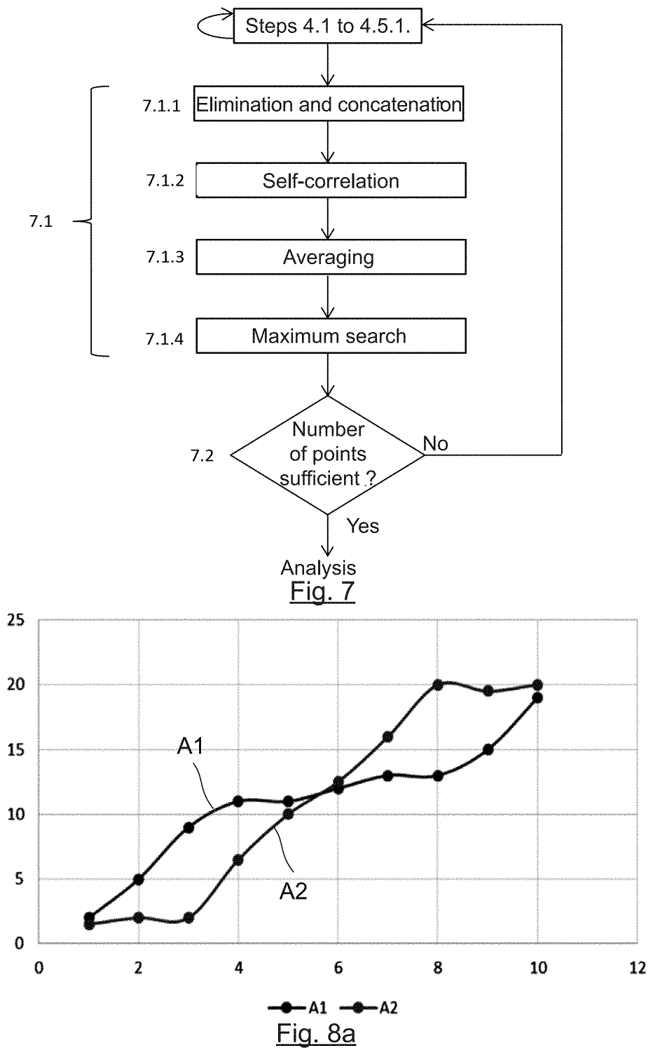

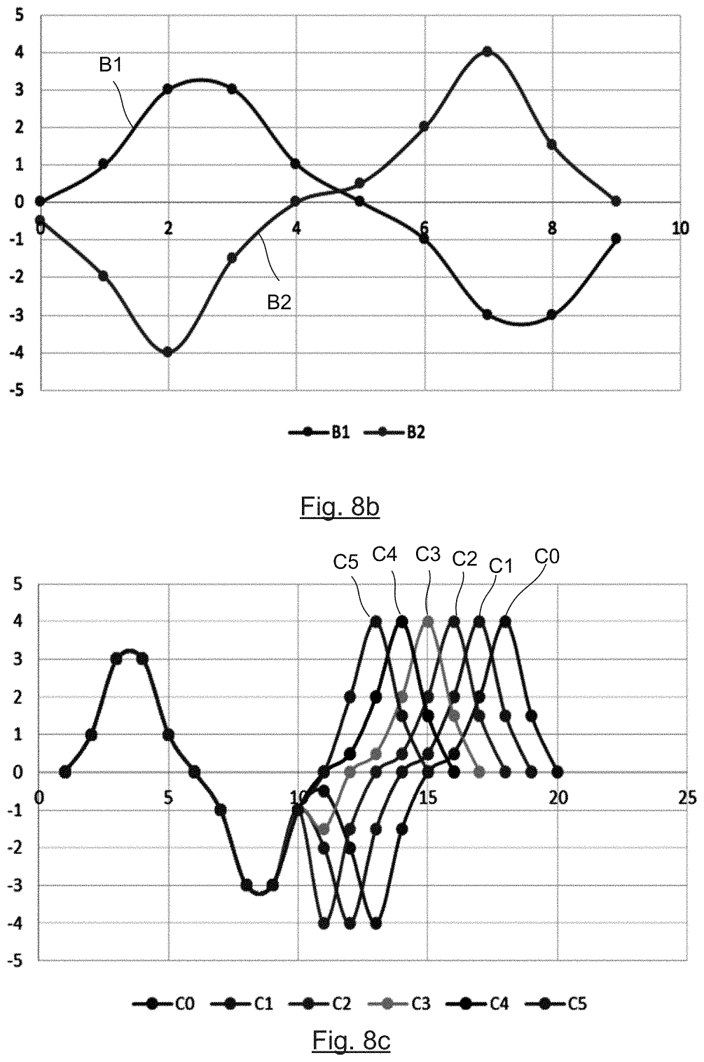

Referring to FIG. 7, a first embodiment shall now be described. FIG. 7 presents a flow chart of the main steps for implementing a method of control of a level of quality of screwing by a screwdriver, relative to a predetermined screw driving objective, according to a third embodiment. Certain steps of this first embodiment are besides illustrated further below through the curves represented in FIG. 8a, FIG. 8b and FIG. 8c.

More particularly, during the implementation of the step 4.3 (according to any one of the implementations mentioned here above in paragraph 5.3), a series of doublets that is representative of the rise in torque of the screwing of a first screw, screwed by the screwdriver of FIG. 1, is obtained (for example after implementing the steps 4.1 and 4.2 described here above). Each doublet comprises an angle value and a torque value. This means that a first table of values associated with the first screw driving operation is constituted. The first table thus obtained is illustrated by the curve A1 of FIG. 8a.

At the implementation of the step 4.4 (according to any one of the above implementations), a second table of values, associated with the first screw driving operation, is determined from the first table of values. The second table of values presents the torque as a function of the angle and is representative of the true characteristic of the first screw.

At the implementation of the step 4.5.1 (according to any one of the implementations mentioned here above), a third table of values presenting the torque as a function of the angle and representative of the disturbance induced by the screwdriver during the rise in torque of the screwing of the first screw, is determined from the first and second tables. The third table associated with the first screw driving operation thus obtained is illustrated by the curve B1 of FIG. 8b.

However, contrary to the two first implementations described here above, the steps 4.3 (for example after implementation of the steps 4.1 and 4.2 described here above), 4.4. and 4.5.1 are implemented for at least a second screwing of screws by the screwdriver. This means that the following are obtained: a first table of values associated with the second screw driving operation (illustrated by the curve A2 of figure FIG. 8a), a second table of values associated with the second screw driving operation, as well as the third table associated with the second screw driving operation (illustrated by the curve B2 of FIG. 8b).

Indeed, the defects searched for in the measurements are related to the screwdriver. Thus, even when different screws are screwed, the defect is found in the series of measurements made during the different operations implemented for screwing screws. Thus, in order to be able to carry out a fine analysis of the measurements made, for example on the basis of sufficient number of measurement points, during a step 7.1, an optimized aggregation of the third table associated with the first screw driving operation and the third table associated with the second screw driving operation is implemented. Such an optimized aggregation comprises an elimination, from the third table associated with the second screw driving operation, of a number of values that is determined according to a criterion of optimization of periodicity. A third candidate aggregated table is thus delivered at the end of the implementation of the step 7.1.

More particularly, at a sub-step 7.1.1, the third table associated with the first screw driving operation and a truncated version of the third table associated with the second screw driving operation, called a truncated third table, are concatenated so as to form an intermediate aggregated table. The truncated third table results from an elimination of a given number of successive values corresponding to angles of minimum amplitude among the values of the third table associated with the second screw driving operation. In other words, it is the first values of the third table associated with the second screw driving operation that are eliminated here.

Besides, the elimination from the third table associated with the second screw driving operation and the concatenation with the third table associated with the first screw driving operation are repeated for different values of given numbers of eliminated values. Thus, a set of intermediate aggregated tables is obtained.

If we reconsider the example of the curves (and vectors of associated values) B1 and B2 of FIG. 8b representing the third tables associated respectively with the first and second screw driving operation, the following formula is for example used to obtain the values of each intermediate aggregate table (the different intermediate aggregate tables are herein indexed by x).

$$∀ x entier ∈ [ 0 ; \frac{longueur {B}_{2}}{2} ] , ∀ a entier ∈ [ 1 ; longueur {B}_{1} + longueur {B}_{2} - x ] , \\ {C}_{x} ( a ) = \{ \begin{matrix}{B}_{1} ( a ) si a \leq longueur {B}_{1} \\ {B}_{2} ( a - longueur {B}_{1} + x ) si longueur {B}_{1} < a < longueur {B}_{1} + longueur B 2\end{matrix} \\ ( “ entier ” means “ integer ” ; “ longueur ” means “ length ” ; “ si ” means “ if ” )$$

The curves C0 to C5, corresponding to the different intermediate aggregated tables of the set of intermediate aggregated tables obtained, are represented by FIG. 8c.

In terms of numerical values, the values corresponding to the curves B1 and B2 are given in the following table:

| Échantillon | B1 | B2 |
|---|---|---|
| 1 | 0 | −0.5 |
| 2 | 1 | −2 |
| 3 | 3 | −4 |
| 4 | 3 | −1.5 |
| 5 | 1 | 0 |
| 6 | 0 | 0.5 |
| 7 | −1 | 2 |
| 8 | −3 | 4 |
| 9 | −3 | 1.5 |
| 10 | −1 | 0 |

The numerical values corresponding to the curves C0 to C5 are then given in the following table:

| Échantillon | C0 | C1 | C2 | C3 | C4 | C5 |
|---|---|---|---|---|---|---|
| 1 | 0 | 0 | 0 | 0 | 0 | 0 |
| 2 | 1 | 1 | 1 | 1 | 1 | 1 |
| 3 | 3 | 3 | 3 | 3 | 3 | 3 |
| 4 | 3 | 3 | 3 | 3 | 3 | 3 |
| 5 | 1 | 1 | 1 | 1 | 1 | 1 |
| 6 | 0 | 0 | 0 | 0 | 0 | 0 |
| 7 | −1 | −1 | −1 | −1 | −1 | −1 |
| 8 | −3 | −3 | −3 | −3 | −3 | −3 |
| 9 | −3 | −3 | −3 | −3 | −3 | −3 |
| 10 | −1 | −1 | −1 | −1 | −1 | −1 |
| 11 | −0.5 | −2 | −4 | −1.5 | 0 | 0 |
| 12 | −2 | −4 | −1.5 | 0 | 0.5 | 2 |
| 13 | −4 | −1.5 | 0 | 0.5 | 2 | 4 |
| 14 | −1.5 | 0 | 0.5 | 2 | 4 | 1.5 |
| 15 | 0 | 0.5 | 2 | 4 | 1.5 | 0 |
| 16 | 0.5 | 2 | 4 | 1.5 | 0 | |
| 17 | 2 | 4 | 1.5 | 0 | | |
| 18 | 4 | 1.5 | 0 | | | |
| 19 | 1.5 | 0 | | | | |
| 20 | 0 | | | | | |

(“Echantillon” means “sample”)

As an alternative, at the sub-step 7.1.1, the third table associated with the second screw driving operation and a truncated version of the third table associated with the first screw driving operation, called a third truncated table, are concatenated so as to form the intermediate aggregated table. More particularly, the third truncated table results from an elimination of a given number of successive values corresponding to angles of maximum amplitude among the values of the third table associated with the first screw driving operation. In other words, it is the last values of the third table associated with the first screw driving operation that are eliminated here.

Besides, the elimination from the third table associated with the first screw driving operation and the concatenation with the third table associated with the second screw driving operation are repeated for different values of the given number of eliminated values, thus delivering the set of intermediate aggregate tables in this alternative.

Returning to FIG. 7, at a sub-step 7.1.2, a self-correlation is implemented for each intermediate aggregated table of the set of intermediate aggregated tables previously obtained. As a result, a corresponding set of self-correlated intermediate aggregated tables is delivered.

If we reconsider the example of the curves (and associated vectors of values) C0 to C5 of FIG. 8c, the following formula is for example used to compute the self-correlation function g(y,x) of each intermediate aggregated table (y here is the argument of each self-correlation function, the different intermediate aggregated tables C0 to C5 being indexed by x):

∀y entier∈[0; longueur Cx],

$$g ( y , x ) = \frac{{Σ}_{i = 0}^{( longueur Cx ) - y - 1} {C}_{x} ( i + y ) \times {C}_{x} ( i )}{( longueur Cx ) - y}$$

(“entier” means “integer”; “longueur” means “length”)

In practice, this operation consists in obtaining the sum of the multiplication, term by term, of the vector Cₓ(i) plus an offset version of the value y, Cₓ(i+y).

At a sub-step 7.1.3, each self-correlated intermediate aggregated table is averaged. Thus, a corresponding set of averaged values is delivered.

If we reconsider the example of the self-correlation functions g(y,x) here above, the following formula is for example used to obtain the averaged values in question:

$$h ( x ) = \frac{{Σ}_{j = 1}^{{G}_{x}} g ( j , x )}{{G}_{x}}$$

with Gₓ the number of values in the vector to be averaged. In terms of numerical values associated with the curves (and vectors of associated values) C0 to C5 of FIG. 8c, we thus obtain:

| | | | | | | |
|---|---|---|---|---|---|---|
| x | 0 | 1 | 2 | 3 | 4 | 5 |
| h(x): | −4.778 | 2.236 | 2.417 | 3.147 | 3.953 | 3.95 |

Thus, an intermediate aggregate table, for which the corresponding averaged value is the maximum among the averaged values, is selected as being the third candidate aggregate table according to the criterion of optimization of periodicity. Thus, the third candidate aggregated table corresponds to the intermediate aggregated table presenting the greatest regularity (in terms of self-correlation) among the different tables of the set of intermediate aggregated tables. Thus, the results of an analysis based for example on an implementation of a Fourier transform are improved, the discontinuities of the analyzed table being minimized. In the above example, the third candidate aggregated table is thus the curve C4 corresponding to x=4.

Besides, when several intermediate aggregated tables have an averaged value that is the same maximum value among the set of averaged values, an intermediate aggregated table corresponding to the elimination of a minimum number of successive values (during the implementation of the elimination of values from the third table associated with the second screw driving operation) is selected from among the intermediate aggregated tables in question as being the third, or selected, candidate aggregated table according to the criterion of optimization of periodicity. Thus, a maximum number of values is obtained in the third candidate aggregated table so as to enable a better resolution of analysis of the table in question.

At a step 7.2, the total number of values of the third candidate aggregated table is tested, for example by comparison with a predetermined threshold. For example, it is decided that the third candidate aggregated table is the third aggregated table when the total number of values of the third candidate aggregate table is above a predetermined threshold. Thus, the number of values of the third aggregated table is considered to be sufficient to be able to obtain an efficient resolution of analysis of the defects of the screwdriver.

As an alternative, when the total number of values of the third candidate aggregated table is below the predetermined threshold, the steps 4.3 (for example after implementation of the steps 4.1 to 4.2 described here above), 4.4 and 4.5.1 (according to any one of the implementations mentioned here above) are again implemented for a new screwing of screws by the screwdriver. A new third corresponding table is thus delivered. On this basis, the step 7.1 of optimized aggregation (according to any one of the above-mentioned embodiments) is again applied to the third candidate aggregated table and the new third table. A new third candidate aggregated table is thus delivered. Thus, when the number of values of the third aggregated table is not sufficient to be able to carry out a fine analysis of the defects of the screwdriver, a new optimized aggregation is implemented iteratively in order to obtain a number of values sufficient for a fine analysis of the results.

In certain embodiments, the new candidate aggregated table is the object of a new test on the number of values that it contains according to a new implementation of the step 7.2 as described here above.

In certain embodiments, the step 7.2 is not implemented and the analysis is done routinely on the third candidate aggregated table obtained from the optimized concatenation of values measured during a predetermined number of screw driving operations (for example two screw driving operations, three screw driving operations, etc.). In these embodiments, the third candidate aggregate table, obtained after the implementing of the step 7.1 for a number of times corresponding to the predetermined number in question, is routinely the third aggregate table.

Returning to FIG. 7, the third aggregate table is analyzed so as to deliver at least one piece of information representing a dispersion and/or a deviation relative to the screw driving objective, resulting from disturbances induced by the screwdriver. For example, such an analysis is implemented according to the technique described here above with reference to the first implementation (cf. steps 4.5.2, 4.5.3, 4.5.4, 4.5.5, 4.5.6, 4.6, according to any one of the implementations mentioned here above) and second implementation of the method of paragraph 3.

### 4.2 Second Embodiment of the Invention

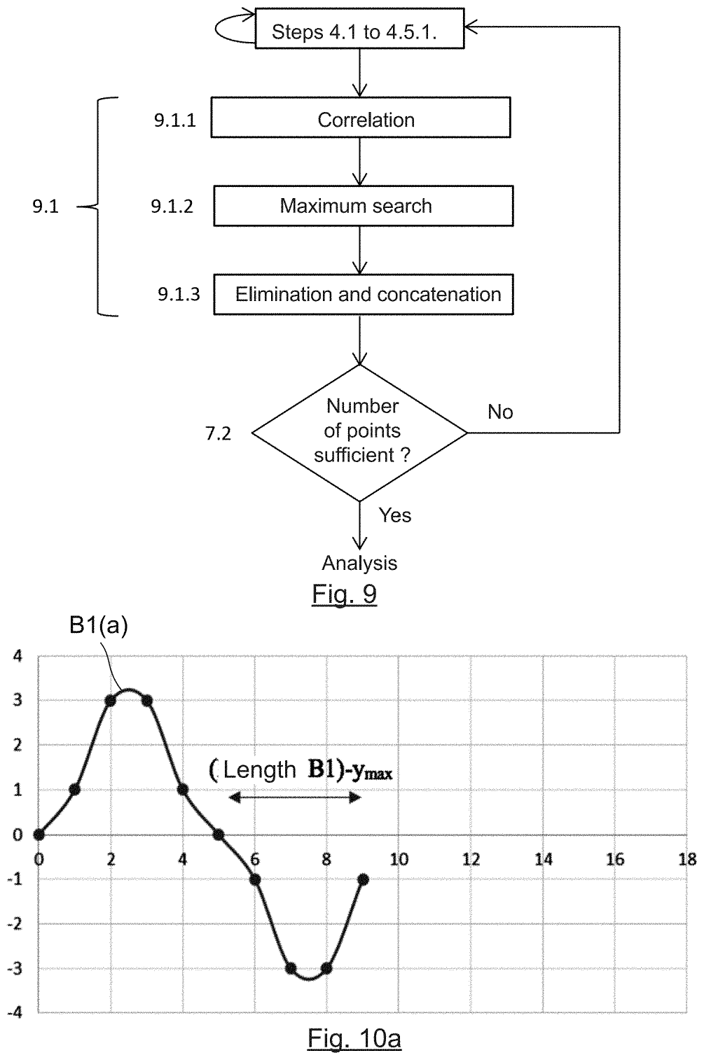

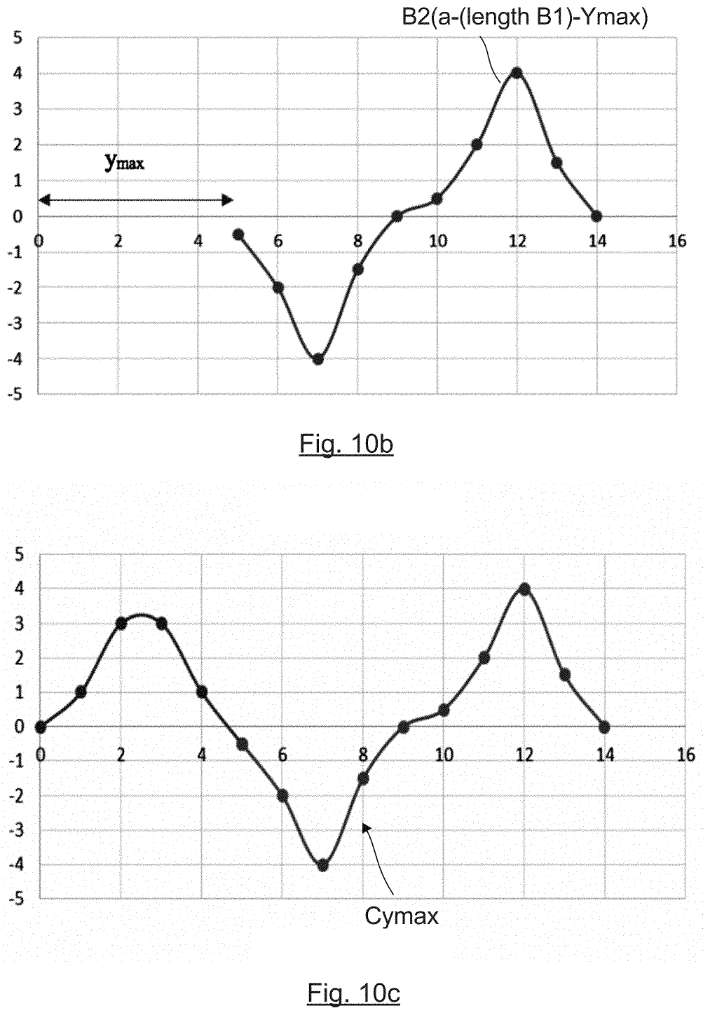

Referring to FIG. 9, a second embodiment shall now be described. FIG. 9 presents a flowchart of the main steps for the implementing of a method of control of a level of quality of screwing by a screwdriver, in relation to a predetermined screw driving objective, according to a fourth example of an embodiment. Certain steps of this second embodiment are besides illustrated further below via the curves represented in FIG. 10a, FIG. 10b and FIG. 10c.

The first embodiment described here above gives very good results. However, the computation of the self-correlation is fairly costly in terms of computation load as well as memory. The second embodiment is used to limit the load of computations at the cost of slightly less satisfactory results. Such results are however sufficient in many practical cases.

Just as in the first embodiment described here above, according to the second embodiment, the steps 4.3 (for example after implementation of the steps 4.1 and 4.2), 4.4 and 4.5.1 are implemented for at least one first screw driving and one second screw driving of screws by the screwdriver. Thus, two first tables of values associated respectively with the first and second screw driving operations, two second tables of values associated with the first and second screw driving operations and two third tables of values associated with the first and second screw driving operations are obtained.

In order to be able to carry out a fine analysis of the measurements made, for example on the basis of a sufficient number of measurement points, at a step 9.1, an optimized aggregation of the third table associated with the first screw driving operation and the third table associated with the second screw driving operation is implemented. Such an optimized aggregation comprises an elimination, from the third table associated with the second screw driving operation, of a number of values that is determined according to a criterion of optimization of periodicity. A third candidate aggregated table is delivered at the end of the implementation of the step 9.1

To this end, during a sub-step 9.1.1, a correlation is computed between, on the one hand, the third table associated with the first screw driving operation and, on the other hand, the third table associated with the second screw driving operation. A correlation function is thus delivered.

If we reconsider the example of the curves (and vectors of associated values) B1 and B2 of FIG. 8b described here above and representing the third tables associated respectively with the first and second screw driving operations, the following formula is for example used to obtain the correlation function in question (y here is the argument of the correlation function):

$$g ( y ) = \frac{{Σ}_{i = 0}^{( longueur {B}_{1} ) - y - 1} {B}_{1} ( i + y ) \times {B}_{2} ( i )}{( longueur {B}_{1} ) - y}$$

$$( “ longueur ” means “ length ” )$$

According to such a formula, the length of B1 must be smaller than or equal to the length of B2. In practice, the roles of B1 and B2 can be interchanged if necessary in order to satisfy such a condition.

At a sub-step 9.1.2, a value with an argument ymax (corresponding in practice to an angle of rotation of the screwdriver) maximizing the correlation function g(y) is determined. The criterion of optimization of periodicity corresponds to the case of elimination, in the third table associated with the first screw driving operation, of a successive number of values, called an optimized number, as a function of the argument value maximizing the correlation function g(y).

Besides, when several values of arguments maximize the correlation function g(y), the optimized number is a function of a maximum value of the argument among the values of the arguments maximizing the correlation function g(y). Thus, a maximum number of values is obtained in the third aggregated table so as to enable a better resolution of analysis of the table in question.

In variants, the search for the values of arguments maximizing the correlation function g(y) is limited to the interval

$$y ∈ [ \frac{longueur {B}_{1}}{2} ; longueur {B}_{1} [ ( “ longueur ” means “ length ” )$$

so as to eliminate at most only half of the values of the third table associated with the first screw driving operation.

At a sub-step 9.1.3, a truncated version of the third table associated with the first screw driving operation and the third table associated with the second screw driving operation are concatenated so as to deliver a third candidate aggregated table. The third truncated table results from an elimination, from the third table associated with the first screw driving operation, of the optimized number of successive values corresponding to arguments of maximum amplitude among the values of the third table associated with the first screw driving operation. In other words, it is the last values of the third table associated with the first screw driving operation that are eliminated here.

For example, if we reconsider the example of the curves (and vectors of associated values) B1 and B2 of FIG. 8b, the third candidate aggregated table corresponds to the curve (and to the vector of associated values) Cymax defined by:

$${C}_{{y}_{m ax}} ( a ) = \{ \begin{matrix}{B}_{1} ( a ) si a \leq ( longueur {B}_{1} ) - {y}_{ma x} \\ {B}_{2} ( a - ( longueur {B}_{1} ) - {y}_{ma x} ) sinon\end{matrix} \\ ( “ si ” means “ if ” ; “ longueur ” means “ length ” ; “ sinon ” means “ else ” )$$

The different corresponding curves, i.e. B1(a), B2(a-(length B1)-Ymax) and Cymax are represented respectively in FIG. 10a, FIG. 10b and FIG. 10c.

The present second embodiment also comprises the step 7.2 (according to any one of the embodiments mentioned here above) for testing the total number of values of the third candidate aggregated table and/or analysis (according to any one of the above embodiments) as described here above with reference to the first embodiment of the method according to the invention.

In certain embodiments, the step 7.2 is not implemented and the analysis is done routinely on the third candidate aggregated table obtained from the optimized concatenation of values measured during a predetermined number of screw driving operations (for example two screw driving operations, three screw driving operations, etc.). In these embodiments, the third candidate aggregate table, obtained after the implementing of the step 9.1 for a number of times corresponding to the predetermined number in question, is routinely or systematically the third aggregated table.

Although the present disclosure has been described with reference to one or more examples, workers skilled in the art will recognize that changes may be made in form and detail without departing from the scope of the disclosure and/or the appended claims.

1. A method for assistance in maintenance of an industrial tool, implementing several rotationally mobile components, wherein the method comprises:
obtaining measurement data representative of an angle and/or a torque during a use of said tool;
analyzing of said measurement data so as to determine at least one piece of quality data representative of possible disturbances induced for each of the components of a set of controlled components, delivering a signature of said tool comprising said quality data;
storing said signature in a non-transitory memory associated with said tool, and readable contactlessly at short distances;
remotely reading said signature in said memory, by using a terminal for assistance in maintenance;
identifying a component requiring action, on the basis of said signature;
obtaining, through said terminal, information on assistance on an intervention to be carried out, comprising 3D information on said tool;
taking at least one image of said tool, by using a camera mounted on said terminal; and
displaying a representation in augmented reality on a screen of said terminal, using the at least one image, and said pieces of 3D information identifying said defective component and/or maintenance operations to be performed.

2. A method for assistance in the maintenance of a tool according to claim 1, wherein the obtaining assistance information comprises connecting to a remote maintenance server, containing a set of pieces of information pertaining to said tool, called a digital twin of the tool, and comprising at least one of the pieces of information belonging to the group consisting of:
a 3D representation of the tool,
an exploded view of the tool,
a data sheet on the tool,
a parts list of the tool,
a report on the calibration of the tool,
a timeline of maintenance of the tool,
a theoretical signature of the tool,
an initial signature of the tool,
at least one signature preceding the tool.

3. The method for assistance in the maintenance of a tool according to claim 1, wherein the analysis is implemented in a hub connected to said tool, receiving said pieces of data for measuring said tool, carrying out said analysis.

4. The method for assistance in the maintenance of a tool according to claim 1, wherein said signature comprises a plurality of frequency lines, and the identification carries out a comparison of an amplitude of each line with a predetermined threshold value.

5. The method for assistance in the maintenance of a tool according to claim 1, wherein said signature comprises a plurality of frequency lines, and said identification implements an analysis of an amplitude of each line between two signatures.

6. The method for assistance in the maintenance of a tool according to claim 1, wherein the analysis takes account of an aggregation of measurement data corresponding to at least two screwing operations.

7. The method for assistance in the maintenance of a tool according to claim 1, wherein the method comprises predicting wear and tear or a defect of a component, by analysis of a series of at least two signatures of said tool and/or a batch of similar tools and/or by comparison with predetermined threshold values.

8. An industrial tool comprising:
several rotationally mobile components;
a memory that is readable via a short-distance contactless connection;
a processor;
a non-transitory computer-readable medium comprising instructions stored thereon which when executed by the processor configure the industrial tool to perform acts comprising:
obtaining measurement data representative of an angle and/or a torque during a use of said tool;
performing either:
analyzing said measurement data so as to determine at least one piece of quality data representative of possible disturbances induced for each of the components of a set of controlled components, delivering a signature of said tool comprising said quality data; or
receiving the signature of the tool from a terminal for assistance in maintenance over the short-distance contactless connection or from another a remote device over another connection;
storing said signature in the memory; and
transmitting the signature stored in the memory to the terminal over the short-distance contactless connection.

9. The tool according to claim 8, wherein said memory comprises an RFID memory capable of communicating according to the Near Field Communication (NFC) protocol.

10. A system of assistance in maintenance of an industrial tool, said tool implementing several components that are rotationally mobile, wherein the system comprises:
at least one remote maintenance server; and
at least one maintenance terminal capable of communicating with said tool and said server,
said tool comprising an associated memory that is contactles sly readable at short distance, containing at least one signature comprising quality data that are representative of possible disturbances induced by each of the components of a set of controlled components, determined on the basis of an analysis of said measurement data representative of an angle and/or a torque value during the use of said tool,
said terminal comprising a contactless reader configured to contactlessly read said signature from the tool and connection element to connect to said remote server, so as to obtain information on assistance on an action to be performed, according to an analysis of said signature.

11. The system according to claim 9, wherein said terminal comprises a camera, capable of obtaining images of said tool, and a data processor configured to present a representation in augmented reality of said tool on a screen, as a function of 3D data delivered by said server.

12. The system according to claim 11, wherein said remote maintenance server contains a set of information elements relative to said tool, called a digital twin of the tool, and comprising at least one of the pieces of information belonging to the group consisting of:
a 3D representation of the tool,
an exploded view of the tool,
a data sheet on the tool,
a parts list of the tool,
a report on the calibration of the tool,
a timeline of maintenance of the tool,
a theoretical signature of the tool,
an initial signature of the tool,
at least one preceding signature of the too.

13. A non-transitory computer-readable medium comprising program code instructions stored thereon for implementing a control method when the instructions are executed by a micro-processor and/or on a computer of an industrial tool comprising: several rotationally mobile components and a memory that is readable via a short-distance contactless connection, wherein the code instructions configure the industrial tool to:
obtain measurement data representative of an angle and/or a torque during a use of said tool;
perform either:
analyzing said measurement data so as to determine at least one piece of quality data representative of possible disturbances induced for each of the components of a set of controlled components, delivering a signature of said tool comprising said quality data; or
receiving the signature of the tool from a terminal for assistance in maintenance over the short-distance contactless connection or from another a remote device over another connection;
store said signature in the memory; and
transmit the signature stored in the memory to the terminal over the short-distance contactless connection.
